(19) United States
(12) Patent Application Publication
(10) Pub. No.: US 2010/0322802 A1
(43) Pub. Date: Dec. 23, 2010

(54) Readily Removable Pump Crosshead

(75) Inventor: Vladimir Kugelev, Arlington, TX (US)

Correspondence Address: BRACEWELL & GIULIANI LLP, P.O. BOX 61389, HOUSTON, TX, 77208-1389, US

(73) Assignee: Weir SPM, Inc., Fort Worth, TX (US)

(21) Appl. No.: 12/821,663

(22) Filed: Jun. 23, 2010

Related U.S. Application Data
(60) Provisional application No. 61/219,521, filed on Jun. 23, 2009.

(51) Int. Cl. F04B 53/14; B23P 6/00

(52) U.S. Cl. 417/437; 29/888.021

(57) ABSTRACT

A reciprocating pump has a driven crankshaft and a connecting rod having an aft end rotatably mounted to the crankshaft. The pump has a stationarily mounted crosshead case in which a crosshead assembly strokes. The crosshead assembly has first and second crosshead members. A retainer pivotally joins the forward end of the connecting rod to the first crosshead member. The second crosshead member has a partially cylindrical recess containing a bushing. The forward end of the connecting rod is in pivotal engagement with the bushing. The second crosshead member is releasably secured to the first crosshead member to allow removal of the second crosshead member and the bushing from the crosshead case without detaching the forward end of the connecting rod from the first crosshead member.

### CROSS-REFERENCE TO RELATED APPLICATION

This application claims priority to provisional application Ser. No. 61/219,521, filed Jun. 23, 2009.

### FIELD OF THE INVENTION

This invention relates in general to oilfield reciprocating pumps, and in particular to a crosshead between a connecting rod and pony rod that is readily removable.

### BACKGROUND OF THE INVENTION

One type of reciprocating pump is employed for fracturing oil and gas wells. During a fracturing operation, a series of frac pumps convey large volumes of fluid into the well. The fluid typically comprises water containing proppants, such as sand. The frac pumps are capable of high pressures, such as 15,000 psi, for causing the earth formation to crack or fracture. The proppants flow into the cracks to prop them open when the pressure is removed.

A typical frac pump has a crankshaft rotated by a power source, such as an engine. Several connecting rods have ends rotatably mounted to the crankshaft. The opposite end of each connecting rod is pivotally connected to a crosshead assembly to convert rotary motion of the crankshaft into linear motion. Each crosshead assembly comprises a crosshead member reciprocally carried within a stationary crosshead case. The crosshead member has an end that contains a partially cylindrical recess that is lined with a bushing. Each connecting rod pivotally mounts to one of the crosshead members in sliding engagement with the bushing. A pony rod secures to an opposite end of each crosshead member. Each pony rod connects to a plunger that is stroked by the pony rod within a cylinder of a fluid end of the pump.

Because of the high pressures and high stroke rate, operators must change the bushings frequently. Normally, the replacement of the bushing requires the operator to disconnect the connecting rod from the crankshaft. This procedure is time consuming.

### SUMMARY

In this invention, the crosshead assembly includes a first crosshead member that reciprocates linearly within a stationarily mounted crosshead case. A retainer pivotally joins the forward end of the connecting rod to the first crosshead member. A second crosshead member has a partially cylindrical recess facing in an aft direction with a bushing located within the recess. The forward end of the connecting rod is in pivotal engagement with the bushing. The second crosshead member is releasably secured to the first crosshead member to allow removal of the second crosshead member and the bushing from the crosshead case without detaching the forward end of the connecting rod from the first crosshead member.

Preferably, a plurality of threaded crosshead member fasteners are employed to secure the second crosshead member to the first crosshead member. The crosshead member fasteners having heads located on a forward end of the second crosshead member so as to be accessible from the forward end. In the preferred embodiment, the first crosshead member comprises a crosshead housing having a cavity, and the second crosshead member comprises an insert mounted in the cavity of the crosshead housing. Preferably, the first crosshead member has an aft end with a window into which the forward end of the connecting rod is inserted.

A pony rod having an aft end is mounted to a forward end of the second crosshead member. A plunger is mounted to a forward end of the pony rod. The pony rod strokes the plunger within a cylinder of a fluid end unit. In the preferred embodiment, the pony rod has an external flange that overlies the heads of the crosshead member fasteners. A plurality of threaded pony rod fasteners extend through the external flange into the second crosshead member.

The second crosshead member may have a neck protruding from the forward end of the second crosshead member. If so, the pony rod has a cavity that slides over the neck. Preferably, the retainer for joining the connecting rod to the first crosshead member comprises a wrist pin that inserts through a hole in the forward end of the connecting rod. The wrist pin is secured to the first crosshead member, such as by threaded fasteners. In the preferred embodiment, he first crosshead member has an enclosure wall surrounding the second crosshead member and a transverse wall extending transversely across the enclosure wall. The wrist pin fasteners extend through the transverse wall into the wrist pin. The enclosure wall of the first crosshead member may have holes adjacent opposite ends of the wrist pin for removing the wrist pin from the forward end of the connecting rod.

### BRIEF DESCRIPTION OF THE DRAWINGS

FIG. 1 is a sectional drawing illustrating a pump constructed in accordance with this invention.

FIG. 2 is an enlarged sectional view of the crosshead assembly of the pump of FIG. 1.

FIG. 3 is a sectional view of the crosshead assembly taken along the line 3-3 of FIG. 2.

FIG. 4 is a sectional view of the crosshead assembly taken along the line 4-4 of FIG. 2.

FIG. 5 is a sectional view of the crosshead assembly taken along the line 5-5 of FIG. 3.

FIG. 6 is a sectional view of the crosshead assembly taken along the line 6-6 of FIG. 2.

FIG. 7 is a sectional view of the forward end of the crosshead assembly removed for replacing a bushing.

### DETAILED DESCRIPTION OF THE INVENTION

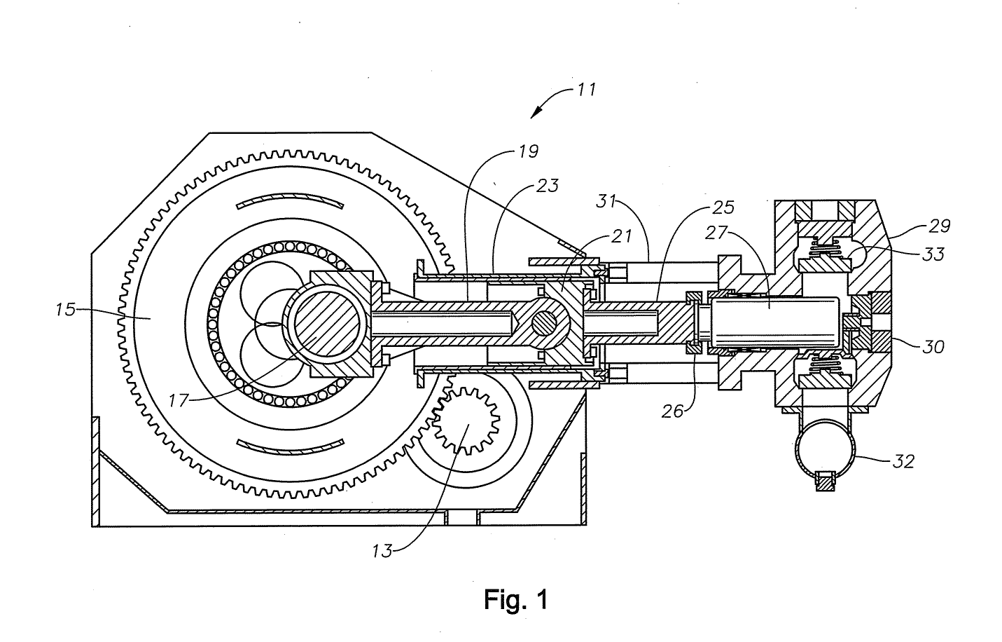

Referring to FIG. 1, pump 11 is of a type typically utilized for oil and gas well service operations, such as pumping high pressure fluid into a well to hydraulically fracture the well. Pump 11 may also be configured for pumping drilling fluid into the well bore during drilling. Pump 11 is a reciprocating pump having a power source connected to a pinion gear 13, such as an electrical motor or diesel engine. Gear 13 drives a bull gear 15, which is connected to a crankshaft 17. Several connecting rods 19 (only one shown) have aft ends rotatably mounted to crankshaft 17. The terms “aft” and “forward” are used herein for convenience only, not in a limiting manner.

Each connecting rod 19 has a forward end that is connected to a crosshead 21. Each crosshead 21 strokes linearly within a stationary crosshead case 23, which is mounted to the pump frame. A pony rod 25 secures to the forward end of each crosshead 21, and a plunger 27 connects to the forward end of pony rod 25 by a clamp 26. The power end of pump 11 causes plunger 27 to stroke linearly within a cylinder in a fluid end block 29. Each cylinder has an access cover 30 secured to fluid end block 29 for inserting and withdrawing one of the plungers 27. Tie rods 31 connect fluid end block 29 to the aft end portion of pump 11. As plunger 27 strokes, fluid is brought into the chamber in forward end 29 from intake 32 and discharged at higher pressure out a discharge (not shown). Intake and discharge valves 33 open and close to draw fluid in and discharge fluid from the chamber.

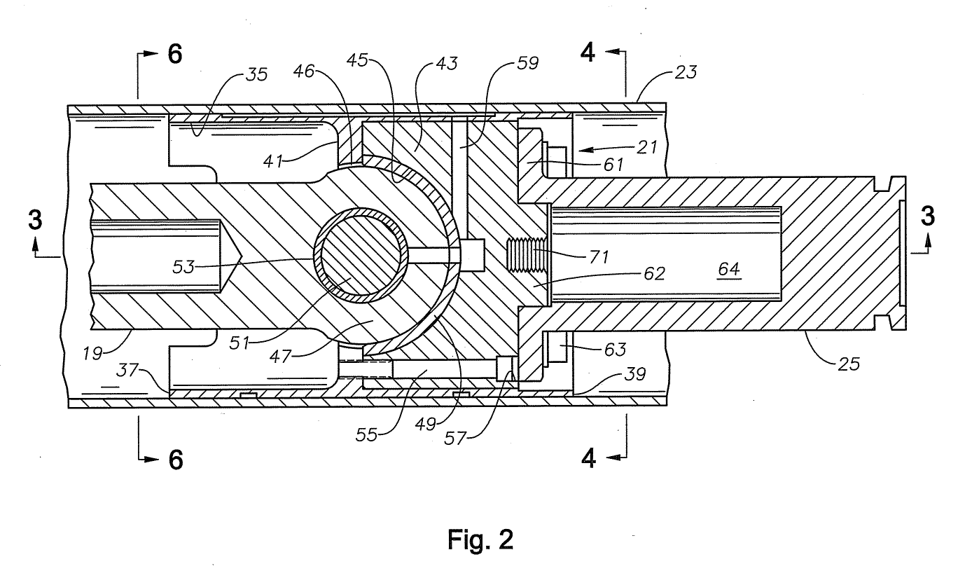

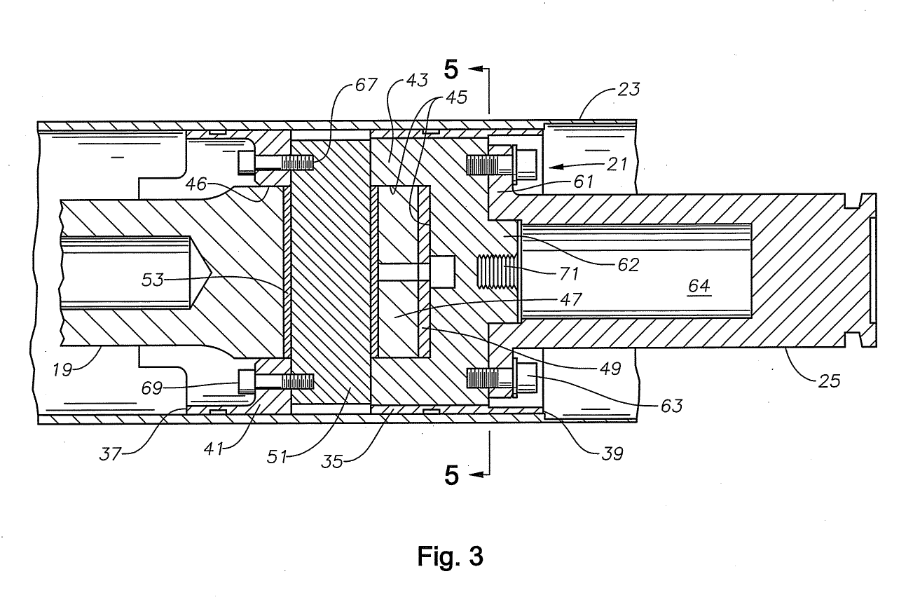

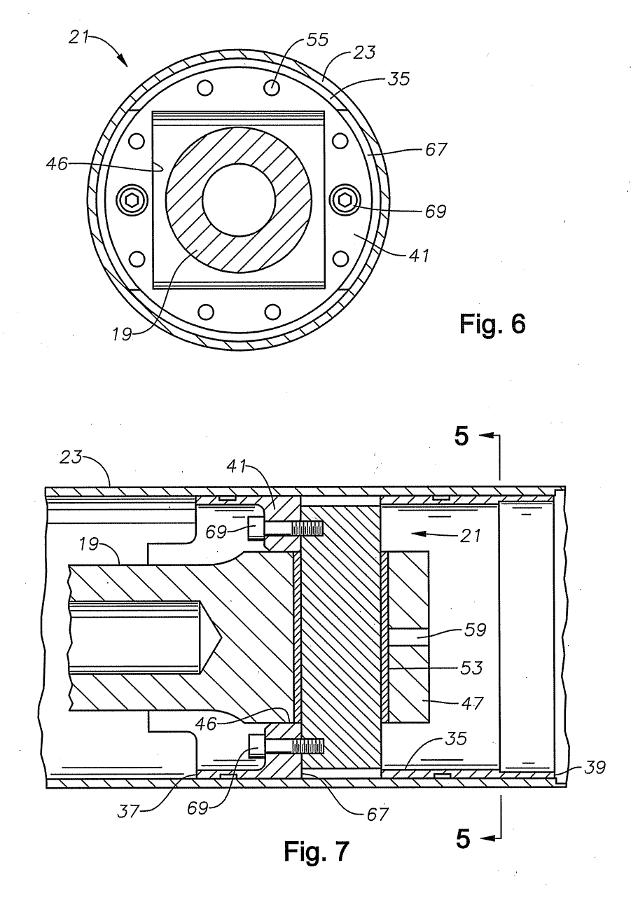

Referring to FIG. 2, each crosshead 21 includes a first crosshead member, also referred to as crosshead housing 35. Crosshead housing 35 has an aft end 37 and a forward end 39. A transverse wall or transverse wall 41 extends between aft end 37 and forward end 39 perpendicular to the axis of crosshead housing 35. Crosshead housing comprises a cylindrical wall or enclosure with transverse wall 41 located intermediate the open aft and forward ends 37, 39. Crosshead 21 includes a second crosshead member, referred to also as an insert 43. Insert 42 is a solid block that fits closely within the cavity of and is secured to crosshead housing 35. Insert 43 has an aft end that abuts a forward side of transverse wall 41. Insert 43 has a partially cylindrical recess 45 that is formed in its aft end. Recess 45 has an axis that is perpendicular to the longitudinal axis of crosshead case 23. Recess 45 registers with a rectangular window 46 located within transverse wall 41. As shown in FIG. 3, recess 45 does not extend completely to each opposite side of insert 43. FIG. 6 illustrates the straight top, bottom and side edges of window 46.

Connecting rod end 47 inserts into window 46 and recess 45. Connecting rod end 47 is generally cylindrical on its exterior and is separated from recess 45 by a bushing 49. Bushing 49 comprises one-half of a sleeve formed of a metal, such as bronze, for serving as a bearing for connecting rod end 47. In this embodiment, a cylindrical wrist pin 51 extends through a transverse bore formed in connecting rod end 47. Wrist pin 51 has an axis that is perpendicular to the longitudinal axis of crosshead 21. A sleeve bearing 53 locates between wrist pin 51 and the bore within connecting rod end 47. Wrist pin 51 has an aft side that is in contact with the forward side of transverse wall 41.

Fasteners such as bolts 55 are preferably employed to fasten insert 43 to the forward side of transverse wall 41. Bolts 55 extend through insert 43 and engage threaded holes formed within the forward side of transverse wall 41. Bolts 55 have heads on the forward end of insert 43. The heads may be fully recessed within counterbores 57 on the so as to provide a smooth or flush forward end for insert 43. Once secured, the forward end of insert 43 may be recessed a short distance from crosshead housing forward end 39. FIG. 5 illustrates a pattern of bolts 55.

Referring again to FIG. 2, a lubricant port 59 may extend vertically downward through crosshead housing 35, insert 43, then axially through bushing 49, connecting rod end 47 to sleeve bearing 53. Lubricant supplied to lubricant port 59 thus communicates with bushing 49 and sleeve bearing 53.

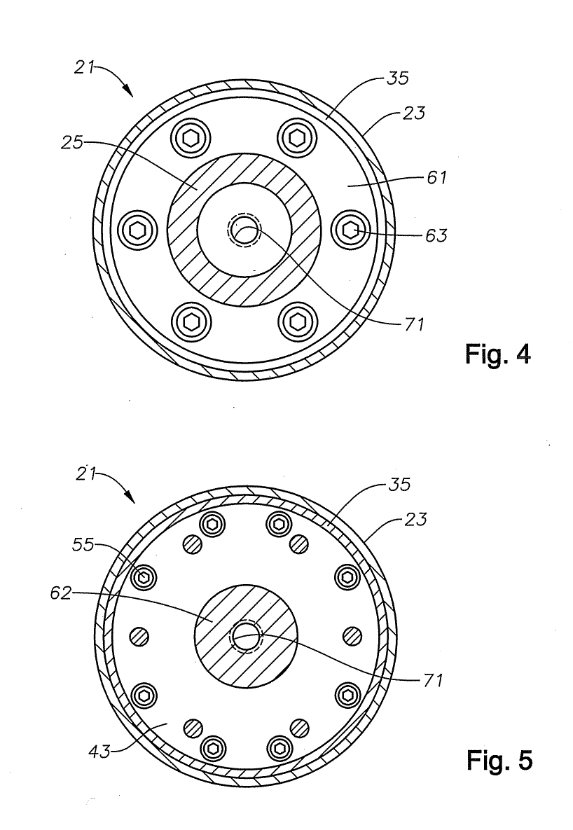

Pony rod 25 attaches to the forward end of insert 43. Pony rod 25 has an external flange 61 with a bolt pattern. Pony rod bolts 63 extend from flange 61 into threaded holes in insert 43. In this embodiment, flange 61 covers the recessed heads of insert bolts 55, as shown also in FIG. 4. Insert 43 may have a cylindrical neck 62 protruding from its forward end that is closely received within a mating cavity 64 in pony rod 25.

Referring to FIGS. 3 and 7, a hole 67 extends transversely through the cylindrical wall of crosshead housing 35 on opposite sides so that holes 67 are coaxial with the axis of wrist pin 51. Holes 67 are slightly larger in diameter than wrist pin 51. When crosshead 21 is removed from crosshead case 23, holes 67 provide access to remove wrist pin 51 from connecting rod end 47. Wrist pin 51 is secured to transverse wall 41 by bolts 69 attached to the aft side of transverse wall 41. Bolts 69 engage threaded holes within wrist pin 51. A threaded hole 71 may be formed in the forward end of neck 62 for receiving a pulling tool.

Periodically, bushing 49 must be replaced for wear. This is handled by removing access cover 30 and disconnecting pony rod 25 from plunger 27 by releasing clamp 26. The operator removes plunger 27 from the fluid end block 29 or at least moves it sufficiently forward in fluid end block 29 so that pony rod 25 may be removed from the side. The operator removes pony rod 25 by unscrewing bolts 63. Once pony rod 25 is detached, the operator then unscrews bolts 55, releasing insert 43 from transverse wall 41. The operator pulls insert 43 and bushing 49 forward toward fluid end block 29. The operator may install a pulling tool in threaded hole 71 to assist in this pulling motion. Once insert 43 and bushing 49 have been removed, the remaining components will appear as in FIG. 7. Wrist pin 51 remains connected to crosshead housing 35. Connecting rod end 47 remains connected to wrist pin 51. Crosshead housing 35 remains within crosshead case 23. The operator removes bushing 49 from its recess 45, then installs a new bushing 49 and reassembles crosshead 21, pony rod 25 and plunger 27. There is no need to disconnect connecting rod 19 from crankshaft 17 to change bushing 49.

While the invention has been shown in only one of its forms, it should be apparent to those skilled in the art that it is not so limited but is susceptible to various changes without departing from the scope of the claims.

1. A pump, comprising:
a driven crankshaft;
a connecting rod having an aft end rotatably mounted to the crankshaft and a forward end that is partially cylindrical;
a stationarily mounted crosshead case;
a first crosshead member that reciprocates linearly within the crosshead case
a retainer that pivotally joins the forward end of the connecting rod to the first crosshead member;
a second crosshead member having a partially cylindrical recess facing in the aft direction;
a partially cylindrical bushing within the recess, the forward end of the connecting rod being in pivotal engagement with the bushing; and
the second crosshead member being releasably secured to the first crosshead member to allow removal of the second crosshead member and the bushing from the crosshead case without detaching the forward end of the connecting rod from the first crosshead member.

2. The pump according to claim 1, further comprising:
a plurality of threaded crosshead member fasteners that secure the second crosshead member to the first crosshead member, the crosshead member fasteners having heads located on a forward end of the second crosshead member.

3. The pump according to claim 1, wherein:
the first crosshead member comprises a crosshead housing having a cavity; and
the second crosshead member comprises an insert mounted in the cavity of the crosshead housing.

4. The pump according to claim 1, wherein:
the first crosshead member has an aft end with a window into which the forward end of the connecting rod is inserted.

5. The pump according to claim 2, further comprising:
a pony rod having an aft end mounted to a forward end of the second crosshead member;
a plunger mounted to a forward end of the pony rod; and
a fluid end unit having a cylinder in which the plunger is stroked by the pony rod.

6. The pump according to claim 5, wherein:
the pony rod has an external flange that overlies the heads of the crosshead member fasteners; and the pump further comprises:
a plurality of threaded pony rod fasteners that extend through the external flange into the second crosshead member.

7. The pump according to claim, 5 wherein:
the second crosshead member has a neck protruding from the forward end of the second crosshead member; and
the pony rod has a cavity that slides over the neck.

8. The pump according to claim 1, wherein the retainer comprises a wrist pin extending through a hole in the forward end of the connecting rod, the wrist pin being secured to the first crosshead member.

9. The pump according to claim 8, wherein:
the first crosshead member has an enclosure wall surrounding the second crosshead member and a transverse wall extending transversely across the enclosure wall; and the retainer further comprises:
a plurality of threaded wrist pin fasteners extending through the transverse wall into the wrist pin.

10. The pump according to claim 8, wherein the enclosure wall has holes adjacent opposite ends of the wrist pin for removing the wrist pin from the forward end of the connecting rod.

11. A pump having a driven crankshaft, a connecting rod having an aft end rotatably mounted to the crankshaft and a forward end that is partially cylindrical, and a stationarily mounted crosshead case, the improvement comprising:
a crosshead housing that reciprocates linearly within the crosshead case along an axis of the crosshead case, the crosshead housing having a cylindrical enclosure wall, a transverse wall extending across the enclosure wall transverse to the crosshead axis, and a window located in the transverse wall, the forward end of the connecting rod being inserted through the window;
a wrist pin extending through the forward end of the connecting rod perpendicular to the cross head axis, the wrist pin being in engagement with a forward side of the transverse wall of the first crosshead member;
an insert located within the enclosure wall of the crosshead housing, the insert having an aft end in abutment with the forward side of the transverse wall, the insert having a partially cylindrical recess facing in the aft direction;
a partially cylindrical bushing within the recess, the forward end of the connecting rod being in pivotal engagement with the bushing; and
a plurality of threaded insert fasteners extending through the insert parallel to the axis into engagement with threaded holes in the transverse wall, the insert fasteners having heads located on a forward end of the insert.

12. The pump according to claim 11, wherein the aft end of the insert is in contact with a forward portion of the wrist pin.

13. The pump according to claim 11, further comprising:
a plurality of threaded wrist pin fasteners extending through the transverse wall from an aft side of the transverse wall into threaded holes in the wrist pin.

14. The pump according to claim 11, wherein the heads of the insert fasteners are recessed within the aft end of the insert, and the pump further comprises:
a pony rod having an external flange overlying the heads of the insert fasteners;
a plurality of threaded pony rod fasteners that extend through the flange into threaded holes in the insert;
a plunger mounted to a forward end of the pony rod; and
a fluid end unit having a cylinder in which the plunger is stroked by the pony rod.

15. The pump according to claim 14, wherein the insert has a neck protruding from the forward end of the insert; and
the pony rod has a cavity that slides over the neck.

16. The pump according to claim 11, wherein the enclosure wall has holes adjacent opposite ends of the wrist pin for removing the wrist pin from the forward end of the connecting rod.

17. The pump according to claim 11 wherein:
the enclosure wall has open forward and aft ends, and the transverse wall is located intermediate the forward and aft ends of the enclosure wall.

18. A method of replacing a bushing located between a connecting rod and a crosshead assembly of a pump, comprising:
(a) providing the crosshead assembly with a first crosshead member and a second crosshead member, the first and second crosshead members being mounted for linear movement within a crosshead case, the second crosshead member having a recess containing the bushing, the forward end of the connecting rod being pivotally joined to the first crosshead member, and the second crosshead member being releasably secured to the first crosshead member; and
(b) detaching the second crosshead member from the first crosshead member and pulling the second crosshead member along with the bushing in a forward direction from the crosshead case while the forward end of the connecting rod remains joined to the first crosshead member and within the crosshead case.

19. The method according to claim 18, wherein:
step (a) further comprises mounting a pony rod to a forward end of the second crosshead member; and the method further comprises,
in step (b) detaching the pony rod from the second crosshead member before detaching the second crosshead member from the first crosshead member.

20. The method according to claim 18, wherein:
wherein the second crosshead member is releasably secured to the first crosshead member by a plurality of threaded fasteners having heads on the forward end of the second crosshead member; and step (b) comprises:
unscrewing the threaded fasteners to detach the second crosshead member from the first crosshead member.
